(19) United States
(12) Patent Application Publication
(10) Pub. No.: US 2013/0204605 A1
(43) Pub. Date: Aug. 8, 2013

(54) SYSTEM FOR TRANSLATING SPOKEN LANGUAGE INTO SIGN LANGUAGE FOR THE DEAF

(71) Applicant: Klaus Illgner-Fehns, Munich (DE)

(72) Inventor: Klaus Illgner-Fehns, Munich (DE)

(73) Assignee: INSTITUT FUR RUNDFUNKTECHNIK GMBH, Munich (DE)

(21) Appl. No.: 13/581,993

(22) PCT Filed: Feb. 28, 2011
(86) PCT No.: PCT/EP2011/052894

§ 371 Date: Sep. 27, 2012

(30) Foreign Application Priority Data
Mar. 1, 2010 (DE) 10 2010 009 738.1

(51) Int. Cl. G06F 17/28

(52) U.S. Cl. CPC G06F 17/28
USPC 704/2

(57) ABSTRACT

For automatising the translation of spoken language into sign language and manage without human interpreter services, a system is proposed, which includes the following features: a database (1), in which text data of words and syntax of the spoken language as well as sequences of video data with the corresponding meanings in the sign language are stored, and a computer (20), which communicates with a database (10) in order to translate fed text data of a spoken language into corresponding video sequences of the sign language, wherein, further, video sequences of initial hand states for definition of transition positions between individual grammatical structures of the sign language are stored in the database (10) as metadata, which are inserted by the computer (20) between the video sequences of the grammatical structures of the sign language during the translation.

The invention relates to a system for translating spoken language into sign language for the deaf.

Sign language is the name given to visually perceivable gestures, which are primarily formed using the hands in connection with facial expression, mouth expression, and posture. Sign languages have their own grammatical structures, because sign languages cannot be converted into spoken language word by word. In particular, multiple pieces of information may be transmitted simultaneously using a sign language, whereas a spoken language consists of consecutive pieces of information, i.e. sounds and words.

The translation of spoken language into a sign language is performed by sign language interpreters, which—comparable to foreign language interpreters—are trained in a full-time study program. For audio-visual media, in particular film and television, there exists a large demand for translation of film and television sound into sign language coming from deaf people, which, however, may only be met inadequately due to default of a sufficient number of sign language interpreters.

The technical problem of the invention is to automatise the translation of spoken language into sign language in order to manage without human interpreter services.

According to the invention, this technical problem is solved by the features in the characterizing portion of the patent claim 1.

Advantageous embodiments and developments of the system according to the invention follow from the dependent claims.

The invention bases on the idea of storing in a database on the one hand text data of words and syntax of a spoken language, for example of the German standard language, and on the other hand sequences of video data of the corresponding meaning in the sign language. As a result, the database comprises an audio-visual language dictionary, in which, for words and/or terms of the spoken language, the corresponding images or video sequences of the sign language are available. For the translation of spoken language into sign language, a computer communicates with the database, wherein textual information, which particularly may also consist of speech components of an audio-visual signal converted into text, is fed into the computer. For spoken texts, the pitch (prosody) and the volume of the speech components are analyzed insofar as this is required for the detection of the semantics. The video sequences corresponding to the fed text data are read out by the computer from the database and connected to a complete video sequence. This may be reproduced self-contained (for example for radio programs, podcast or the like) or, for example, fed into an image overlay, which overlays the video sequences in the original audio-visual signal as a “picture in picture”. Both image signals may be synchronized to each other by means of a dynamical adjustment of the playback speed. Hence, a larger time delay between spoken language and sign language may be reduced in the “on-line” mode and largely avoided in the “off-line” mode.

Because the initial hand states between the individual grammatical structures must be recognisable for understanding of the sign language, further, video sequences of initial hand states are stored in the form of metadata in the database, wherein the video sequences of the initial hand states are inserted between the grammatical structures of the sign language during the translation. Apart from the initial hand states, the transitions between the individual segments play an important role for obtaining a fluent “visual” speech impression. For this purpose, corresponding crossfades may be computed by means of the stored metadata regarding the initial hand states and the hand states at the transitions so that the hand positions follow seamlessly at the transition from one segment to the next segment.

The invention is described in more detail by means of the embodiments in the drawings.

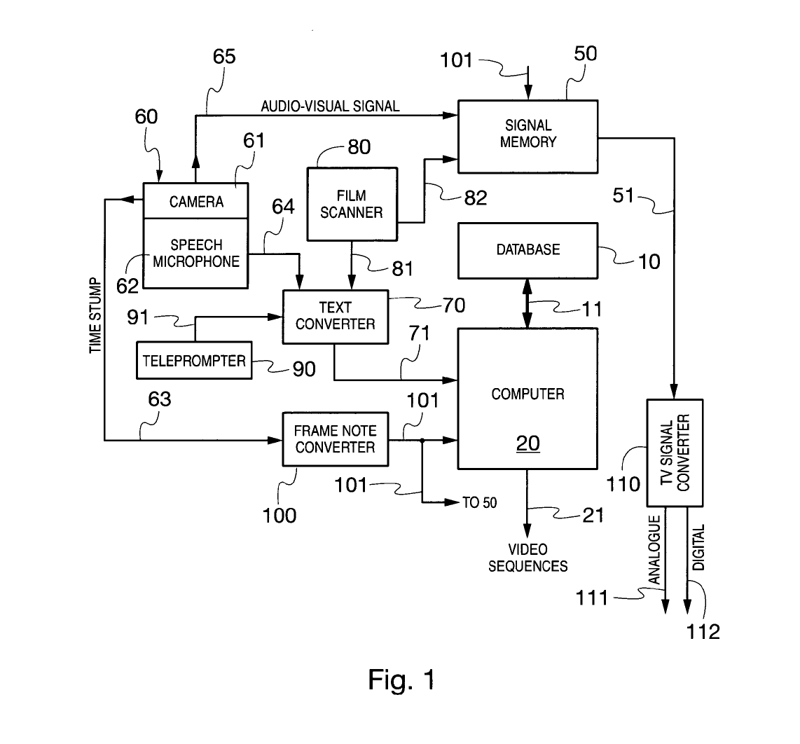

FIG. 1 shows a schematic block diagram of a system for translating spoken language into a sign language for the deaf in form of video sequences;

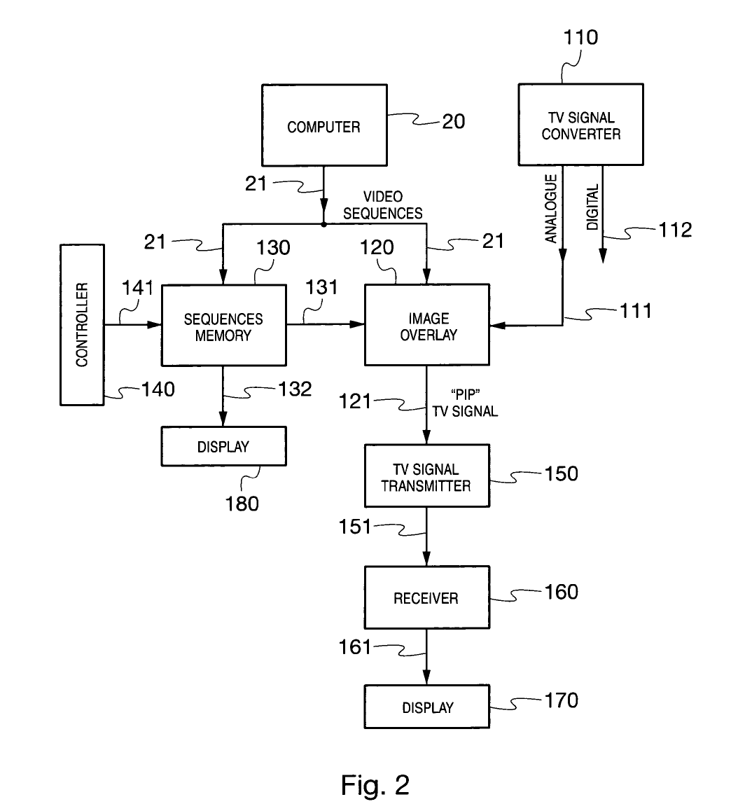

FIG. 2 shows a schematic block diagram of a first embodiment for the processing of the video sequences generated using the system according to FIG. 1, and

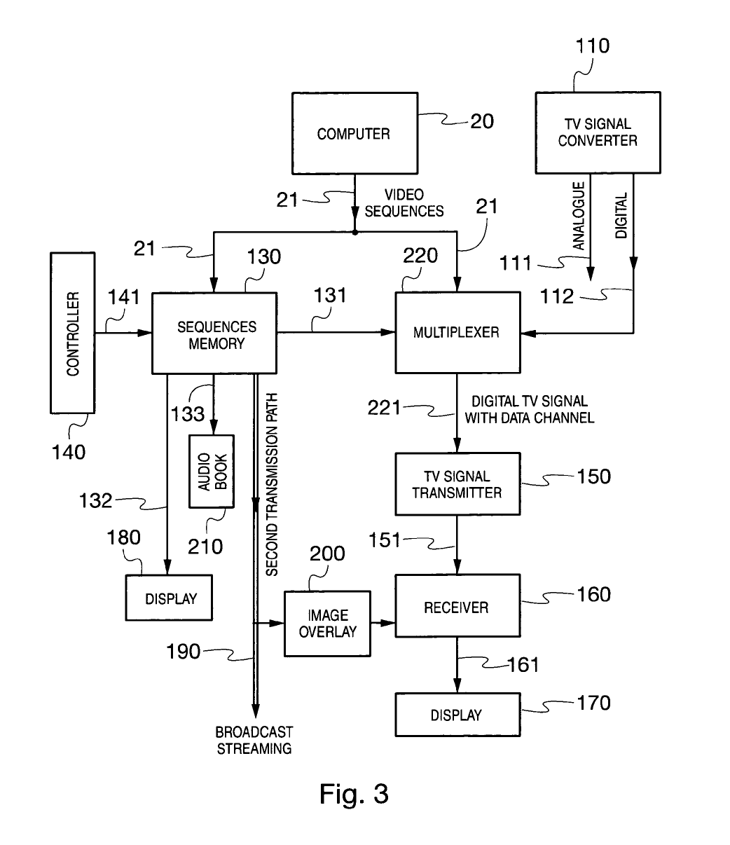

FIG. 3 shows a schematic block diagram of a second embodiment for the processing of the video sequences generated using the system according to FIG. 1.

In FIG. 1, the reference sign 10 designates a database, which is constructed as an audio-visual language dictionary, in which, for words and/or terms of a spoken language, the corresponding images of a sign language are stored in form of video sequences (clips).

Via a data bus 11, the database 10 communicates with a computer 20, which addresses the database 10 with text data of words and/or terms of the spoken language and reads out the corresponding, therein stored video sequences of the sign language onto its output line 21. Further and preferably, in the database 10, metadata for initial hand states of the sign language may be stored, which define transition positions of the individual gestures and, in form of transition sequences, are inserted between consecutive video sequences of the individual gestures. In the following, the generated video and transition sequences are referred to only as “video sequences”.

In a first embodiment shown in FIG. 2, for the processing of the generated video sequences, the video sequences read out by the computer 20 onto the output line 21 are fed to an image overlay 120 either directly or, after intermediate storing in a video memory (“sequence memory”) 130 has taken place, via its output 131. Additionally, the video sequences stored in the video memory 130 may be displayed on a display 180 via the output 132 of the memory 130. The output of the stored video sequences onto the outputs 131 and 132 is controlled by a control 140, which is connected to the memory 130 via an output 141. Further, an analogue television signal from a television signal converter 110 converting an audio-visual signal into a standardized analogue television signal at its output 111 is fed into the image overlay 120. The image overlay 120 inserts the read-out video sequences in the analogue television signal, for example, as “picture in picture” (“picture in picture”, abbreviated as “PIP”). The “PIP” television signal so generated at the output 121 of the image overlay 120 is transmitted according to FIG. 2 from a television signal transmitter 150 via an analogue transmission path 151 to a receiver 160. During the reproduction of the received television signal 50 on a reproduction apparatus 170 (display), the image component of the audio-visual signal and, separated therefrom, the gestures of a sign language interpreter may be observed simultaneously.

In a second embodiment shown in FIG. 3, for the processing of the generated video sequences, the video sequences read out by the computer 20 onto the output line 21 are fed to a multiplexer 220 either directly or, after intermediate storing in a video memory (“sequence memory”) 130 has taken place, via its output 131. Further, a digital television signal comprising a separate data channel, in which the multiplexer 220 inserts the video sequences, is fed into the multiplexer 220 from the television signal converter 110 from its output 112. The digital television signal so processed at the output 221 of the multiplexer 240 is in turn transmitted to a receiver 160 via a television transmitter 150 via a digital transmission path 151. During reproduction of the received digital television signal 50 on a reproduction apparatus 170 (display), the image component of the audio-visual signal and, separated therefrom, the gestures of a sign language interpreter may be observed simultaneously.

As shown in FIG. 3, the video sequences 21 may further be transmitted to a user from the memory 130 (or directly from the computer 20) via an independent second transmission path 190 (for example via the internet). In this case, no insertion of the video sequences in the digital television signal by a multiplexer 220 takes place. Rather, the video sequences and transition sequences received by the user via the independent second transmission path 190 may be inserted on user demand and via an image overlay 200 in the digital television signal received by the receiver 160 and the gestures may be reproduced on the display 170 as picture in picture.

Another alternative shown in FIG. 3 is that the generated video sequences 21 are played individually via the second transmission path 190 (broadcast or streaming) or are offered for a retrieval (for example for an audio book 210) via an output 133 of the video memory 130.

Depending on which form the audio-visual signal is generated or deduced, FIG. 1 shows, as an example, an offline version and an online version for the feeding of the text data into the computer 20. In the online version, the audio-visual signal is generated in a television or film studio by means of a camera 61 and a speech microphone 62. Via a sound output 64 of the speech microphone 60, the speech component of the audio-visual signal is fed into a text converter 70, which converts the spoken language into text data comprising words and/or terms of the spoken language and thus generates an intermediate format. Then, the text data is transmitted to the computer 20 via a text data line 71, where they address the corresponding data of the sign language in the database 10.

In the case of using what is referred to as “telepromter” 90 in the studio 60, at which a speaker reads the text to be spoken from a monitor, the text data of the telepromter 90 is fed into the text converter 70 via the line 91 or (not shown) directly into the computer 20 via the line 91.

In the offline version, the speech component of the audio-visual signal is, for example, scanned at the audio output 81 of a film scanner 80, which converts a film into a television sound signal. Instead of a film scanner 80, a disc storage medium (for example DVD) may also be provided for the audio-visual signal. The speech component of the scanned audio-visual signal in turn is fed into the text converter 70 (or another, not explicitly shown text converter), which, for the computer 20, converts the spoken language into text data comprising words and/or terms of the spoken language.

The audio-visual signals from the studio 60 or the film scanner 80 may further preferably be stored on a signal memory 50 via their outputs 65 or 82. Via its output 51, the signal memory 50 feeds the stored audio-visual signal into the television converter 110, which generates an analogue or digital television signal from the fed audio-visual signal. Naturally, it is also possible to feed the audio-visual signals from the studio 60 or the film scanner 80 directly into the television signal converter 110.

In case of radio signals, above remarks apply in an analogue manner except that no video signal exists in parallel to the audio signal. In the online mode, the audio signal is directly recorded via the microphone 60 and fed into the text converter 70 via 64. In the offline mode, the audio signal of an audio file, which may be present in any format, is fed into the text converter. For optimizing the synchronisation of the video sequences with the gestures and the parallel video sequence, a logic 100 (for example a frame rate converter) may optionally be connected, which, by means of the time information from the original audio signal and the video signal (time stamp of the camera 61 at the camera output 63), dynamically varies (accelerates or decelerates) both the playback speed of the gesture video sequence from the computer 20 and of the original audio-visual signal from the signal memory 50. For this purpose, the control output 101 of the logic 100 is connected both with the computer 20 and the with the signal memory 50. By means of this synchronisation, a larger time delay between the spoken language and the sign language may be reduced in the “on-line” mode and may largely be avoided in the “off-line” mode.

1. A system for translating spoken language into a sign language for the deaf, characterized by comprising:
a database (1), in which text data of words and syntax of the spoken language as well as sequences of video data with the corresponding meanings in the sign language are stored, and
a computer (20), which communicates with a database (10) in order to translate fed text data of a spoken language into corresponding video sequences of the sign language,
wherein, further, video sequences of initial hand states for definition of transition positions between individual grammatical structures of the sign language are stored in the database (10) as metadata, which are inserted by the computer (20) between the video sequences of the grammatical structures of the sign language during the translation.

2. The system according to claim 1, wherein it comprises a device (120; 220) for inserting the video sequences translated by the computer (20) in an audio-visual signal.

3. The system according to claim 1, wherein it comprises a converter (70) for converting the sound signal component of an audio-visual signal into text data and for feeding the text data into the computer (20).

4. The system according to claim 1, wherein a logic device (100) is provided, which feeds a time information deduced from the audio-visual signal into the computer (20), wherein the fed time information dynamically varies both the playback speed of the video sequence from the computer (20) and of the original audio-visual signal.

5. The system according to claim 1, wherein the audio-visual signal is transmitted to a receiver (160) as digital signal via a television signal transmitter (150), and wherein an independent second transmission path (190) is provided for the video sequences (21), via which the video sequences (21) are transmitted to a user from a video memory (130) or directly from the computer (20) and that an image overlay (200) is connected with the receiver (160) in order to insert the video sequences (21) transmitted to the user via the independent second transmission path (190) in the digital television signal received by the receiver (160) as picture in picture.

6. The system according to claim 1, wherein an independent second transmission path (190) is provided for the video sequences (21), via which the video sequences (21) are played from the a video memory (130) or directly from a computer (20) for broadcast or streaming applications or offered for a retrieval (for example for an audio book 210).

7. A receiver for a digital audio-visual signal, wherein an image overlay (200) is connected with the receiver (160) in order to insert the video sequences (21) transmitted via an independent second transmission path (190) in the digital television signal received by the receiver (160) as picture in picture.
